(19) United States
(12) Patent Application Publication
(10) Pub. No.: US 2023/0021836 A1
(43) Pub. Date: Jan. 26, 2023

(54) UNDUCTED THRUST PRODUCING SYSTEM

(71) Applicant: General Electric Company, Schenectady, NY (US)

(72) Inventors: David Baker Riddle, Cincinnati, OH (US); Keith Edward James Blodgett, Milford, OH (US); Timothy Richard DePuy, Liberty Township, OH (US); William Joseph Bowden, Cleves, OH (US)

(21) Appl. No.: 17/382,467

(22) Filed: Jul. 22, 2021

(51) Int. Cl. B64D 27/12

(52) U.S. Cl. CPC B64D 27/12; B64D 2027/005

(57) ABSTRACT

An aircraft includes a fuselage, a wing connected to and extending outward from the fuselage, and an engine mounted to the wing. The engine includes turbomachine defining a centerline axis, a fan, and an exhaust section with an outlet nozzle. The turbomachine defines a centerline axis. The fan is connected to and is disposed upstream from the turbomachine. The fan is disposed to rotate about the centerline axis. During operation of the engine, an exhaust stream is expelled from the outlet nozzle of the exhaust section. The exhaust stream defines a mean direction of flow in the downstream direction from the exhaust section. The mean direction of flow defines a first angle with the centerline axis of the turbomachine that is greater than zero such that the centerline axis is oriented downwardly along the vertical direction relative to the mean direction of flow of the exhaust stream.

### FIELD

The present disclosure relates to an engine for an aircraft. In particular, the present disclosure relates to relative axial alignment of turbofan engine turbomachinery relative to an exhaust aerodynamic flowpath.

### BACKGROUND

A gas turbine engine generally includes a turbomachine and a rotor assembly. Gas turbine engines, such as turbofan engines, may be used for aircraft propulsion. In the case of a turbofan engine, the rotor assembly may be configured as a fan assembly. Other types of engines include propfan engines, turbojet engines, turboshaft engines, turboprop engines, turbofan engines, and unducted turbine engines.

The inventors of the present disclosure have found that in certain unducted turbine engines, the lack of a ducted engine inlet can result in airflow alignment issues with the fan face which can negatively impact the acoustic and aerodynamic performance of the system. Accordingly, the inventors of the present disclosure have discovered that improvements in unducted turbine engine design to address these issues would be welcomed in the art.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a perspective view of a portion of an aircraft with an exemplary unducted fan engine according to various embodiments of the present subject matter.

FIG. 2 is a side view of an aircraft with an exemplary unducted fan engine according to various embodiments of the present subject matter.

FIG. 3 is a partially transparent side view of the unducted fan engine and shows a flowpath passing through the unducted fan engine.

FIG. 4 is a partially transparent side view of a downstream portion of an exhaust section of the unducted fan engine.

FIG. 5 is a partially transparent side view of a downstream portion of an alternate exhaust section of the unducted fan engine.

FIG. 6 is a perspective view of a portion of a wing of the aircraft showing a portion of the pylon extending along an upper surface of the wing.

FIG. 7 is a perspective isolation view of the pylon with a guide vane mounted onto the pylon.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin. These approximating margins may apply to a single value, either or both endpoints defining numerical ranges, and/or the margin for ranges between endpoints.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

A “third stream” as used herein means a non-primary air stream capable of increasing fluid energy to produce a minority of total propulsion system thrust. A pressure ratio of the third stream may be higher than that of the primary propulsion stream (e.g., a fan or propeller driven propulsion stream). The thrust may be produced through a dedicated nozzle or through mixing of an airflow through the third stream with a primary propulsion stream or a core air stream, e.g., into a common nozzle.

In certain exemplary embodiments an operating temperature of the airflow through the third stream may be less than a maximum compressor discharge temperature for the engine, and more specifically may be less than 350 degrees Fahrenheit (such as less than 300 degrees Fahrenheit, such as less than 250 degrees Fahrenheit, such as less than 200 degrees Fahrenheit, and at least as great as an ambient temperature). In certain exemplary embodiments these operating temperatures may facilitate heat transfer to or from the airflow through the third stream and a separate fluid stream. Further, in certain exemplary embodiments, the airflow through the third stream may contribute less than 50% of the total engine thrust (and at least, e.g., 2% of the total engine thrust) at a takeoff condition, or more particularly while operating at a rated takeoff power at sea level, static flight speed, 86 degree Fahrenheit ambient temperature operating conditions.

The term “mean direction of flow,” with respect to an exhaust stream, refers to a mean average of all flow from a particular exhaust, taking into account both magnitude and direction of all of such flow. The mean direction of flow may refer to the mean direction of flow during a steady state operation, such as during cruise operations.

Furthermore in certain exemplary embodiments, aspects of the airflow through the third stream (e.g., airstream, mixing, or exhaust properties), and thereby the aforementioned exemplary percent contribution to total thrust, may passively adjust during engine operation or be modified purposefully through use of engine control features (such as fuel flow, electric machine power, variable stators, variable inlet guide vanes, valves, variable exhaust geometry, or fluidic features) to adjust or optimize overall system performance across a broad range of potential operating conditions.

The present disclosure is generally related to the relative axial alignment of sections of an unducted fan engine. The disclosure presents a pitch down arrangement of an unducted fan of the unducted fan engine relative to an engine centerline. The disclosure addresses challenges of the unducted fan engine's lack of an inlet fairing or nacelle surrounding the unducted fan to align an inlet flow with a fan face of the unducted fan for both acoustic and performance reasons. The proposed configurations disclosed herein may pitch the fan face of the unducted fan downwardly to address the inlet flow being encountered by the unducted fan at an upwash angle (as may be caused by an airfoil shape of a wing to which the engine is attached). Further, proposed configurations disclosed herein may then realign an exhaust section of the engine with a freestream airflow to avoid blowing hot gas onto the wing and to align the engine thrust with a centerline axis of the aircraft.

Certain exemplary embodiments of the present disclosure additionally may include a canting and non-axisymmetric configuration of a working gas flowpath outlet and a third stream flowpath outlet, as well as a pylon design with an integrated outlet guide vane. Additionally, the engine may include a plurality of outlet guide vanes with one or more of the outlet guide vanes integrated with the pylon in such a way as to jointly work to de-swirl the fan exhaust while the fan exhaust passes over the pylon and optimally prepare the air flow as the air flow approaches the wing.

As disclosed, the engine configurations enable improvements in aerodynamics, acoustics, and the installed performance, and in particular with an unducted fan engine concept. The embodiments presented herein additionally enable configurations of the engine that enable improved fuel burn, power efficiency, and less weight of the engine.

Referring now to the drawings, wherein identical numerals indicate the same elements throughout the figures, FIG. 1 is a perspective view of a portion of an aircraft 10. The aircraft 10 includes a fuselage 12, a wing 14 (with an upper surface 16), a pylon 18, and an engine 20, and defines a vertical direction V and a downstream direction D. In this example, downstream direction D is a direction of airflow from a front or forward end (e.g., to the left in FIG. 1) of aircraft 10 to a rear or aft end (e.g., to the right in FIG. 1) of aircraft 10. Engine 20 of the aircraft 10 includes a fan 22 having a plurality of fan blades 26, a spinner or nose 28, stationary guide vanes 32, a casing 34, and an exhaust section 36. Further, fan 22 of engine 20 defines a centerline axis 24 and a direction of rotation 30.

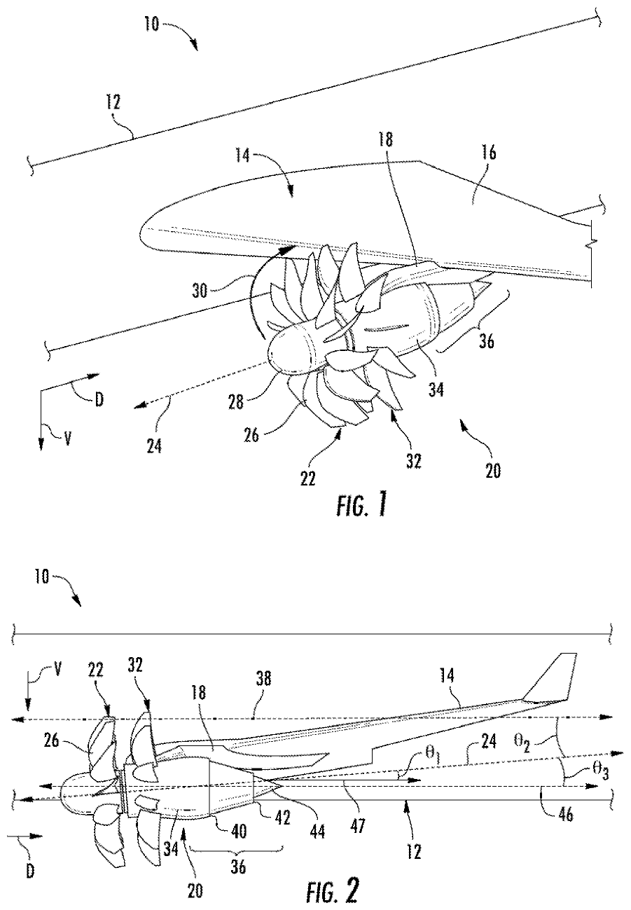

Referring also to FIG. 2, a side view of aircraft 10 is provided. As will be appreciated from the view of FIG. 2, aircraft 10 further defines a fuselage centerline 38, and engine 20 further includes a bypass outlet nozzle 40, an outlet nozzle 42, and a core plug 44, and defines an outlet axis 46, an exhaust stream 47, a first angle θ₁, a second angle θ₂, and a third angle θ₃. As presented herein, FIGS. 1 and 2 are discussed in tandem.

Fuselage 12 is a main body or vessel section of aircraft 10 that contains cargo, passengers, a crew, or a combination thereof during normal operation. Wing 14 is an aerodynamic portion of aircraft 10 that provides lift for aircraft 10. Wing 14 is mounted to and extends from fuselage 12. Upper surface 16 is a surface extending along a top-side of wing 14 relative to vertical direction V (shown as pointing downwards in FIG. 1). As will be appreciated, the wing 14 may define an airfoil shape, and upper surface 16 may be suction side of the airfoil. Such a configuration may cause an upwash of the airflow approaching the wing 14 during flight, as will be described further below.

Engine 20 is mounted to the wing 14. More specifically, for the embodiment depicted, the aircraft 10 includes the pylon 18. Pylon 18 is a mount extending between wing 14 and engine 20. Pylon 18 connects engine 20 to wing 14.

It will be appreciated, however, that in other exemplary embodiments, engine 20 may be mounted to the wing 14 in any other suitable manner. For example, in other embodiments, engine 20 may be at least partial integrated into the wing 14 in a blended wing configuration.

Engine 20 is a machine or thrust producing system for providing thrust for aircraft 10. In this example, engine 20 is configured as an unducted single fan (e.g., fan 22). More specifically, in the embodiment shown, engine 20 includes a single row of unducted rotor blades (e.g., fan blades 26, as described below). Engine 20 with fan 22, provides thrust for aircraft 10.

Fan 22 is a rotatable propeller configured to rotate about centerline axis 24. Fan 22 is mounted at an upstream end of engine 20 and is configured to rotate relative to casing 34. As shown in FIG. 2, an upstream direction is to the left.

Centerline axis 24 is an axial centerline extending through a centerpoint of fan 22 and about which fan 22 rotates.

Fan 22 includes the fan blades 26. Fan blades 26 are airfoil vanes configured to rotate with fan 22 about centerline axis 24. In this example, fan blades 26 are unducted rotor blades. Put another way, fan blades 26 define a stage of unducted rotor blades. Fan blades 26 are connected to and extend outward along a radial direction from nose 28 of fan 22. Nose 28 is a spinner of engine 20. Direction of rotation 30 is a direction of rotation which fan 22 including fan blades 26 rotates.

Moreover, for the exemplary embodiment depicted, engine 20 includes outlet guide vanes 32. Guide vanes 32 are non-rotating airfoils or stator vanes that guide or redirect a direction of airflow across guide vanes 32. Guide vanes 32 define a stage of outlet guide vanes that are located downstream of fan blades 26 (e.g., the stage of unducted rotor blades). In one example, guide vanes 32 can be fixed stator vanes. In another example, guide vanes 32 can be adjustable or variable pith guide vanes. Guide vanes 32 are mounted to a portion of casing 34. In one example, guide vanes 32 can be functionally coupled to pitch change mechanisms located inside of casing 34. Casing 34 is a housing or exterior wall of engine 20. Casing 34 is disposed about an exterior of engine 20 to form an external barrier or wall of engine 20.

Exhaust section 36 of engine 20 is a downstream portion of engine 20 that is configured to expel an exhaust stream from engine 20 for propulsion of aircraft 10.

Fuselage centerline 38 is a centerline axis passing through a center of fuselage 12 and extending in the downstream direction D. Fuselage centerline 38 extends along and passes through an axial centerpoint of fuselage 12 for a majority of the fuselage 12 (e.g., excepting a nose portion of the fuselage 12 and empennage portion of the aircraft 10).

Bypass outlet nozzle 40 and outlet nozzle 42 are outlet nozzles for airstreams passing through an interior of a portion of engine 20.

Core plug 44 is a cap or a fluid guide insert. In this example, core plug 44 is a conical piece of solid or hollow material for directing airflow out of outlet nozzle 42. In other examples, core plug 44 can include a non-conical shape. Core plug 44 is disposed at a downstream most end (e.g., right most end in FIGS. 1 through 3) of exhaust section 36.

Outlet axis 46 is a centerline axis passing through an axial center of exhaust section 36 and passing through a tip of core plug 44. Outlet axis 46 is defined in part by outlet nozzle 42. In this example, outlet axis 46 is parallel to fuselage centerline 38 (see e.g., FIG. 2).

Exhaust stream 47 is flow of air expelled from outlet nozzle 42. In this example, a direction of exhaust stream 47 is parallel to downstream direction D and perpendicular to vertical direction V. Also in this example, exhaust stream 47 defines a mean direction of flow in downstream direction D from exhaust section 36 (the mean direction of flow exemplified by the schematic representation of the exhaust stream 47 in the Figures).

As shown in FIG. 2, first angle θ₁ is defined by the relative angle between centerline axis 24 and exhaust stream 47, second angle θ₂ is defined by the relative angle between centerline axis 24 and fuselage centerline 38, and third angle θ₃ is defined by the relative angle between centerline axis 24 and outlet axis 46 of exhaust section 36. With respect to first angle θ₁ for example, the mean direction of flow of exhaust stream 47 defines first angle θ₁ with centerline axis 24 greater than zero and less than about 10 degrees (such as less than about 7 degrees), such that centerline axis 24 is oriented more downwardly along vertical direction V relative to the mean direction of flow of exhaust stream 47. In certain exemplary embodiments, third angle θ₃ is greater than zero (such as equal to or greater than 5°, such as equal to or greater than 10°, such as equal to or greater than 15°, such as equal to 20°). In certain exemplary embodiments, third angle θ₃ may also be referred to as a nozzle angle θ₃.

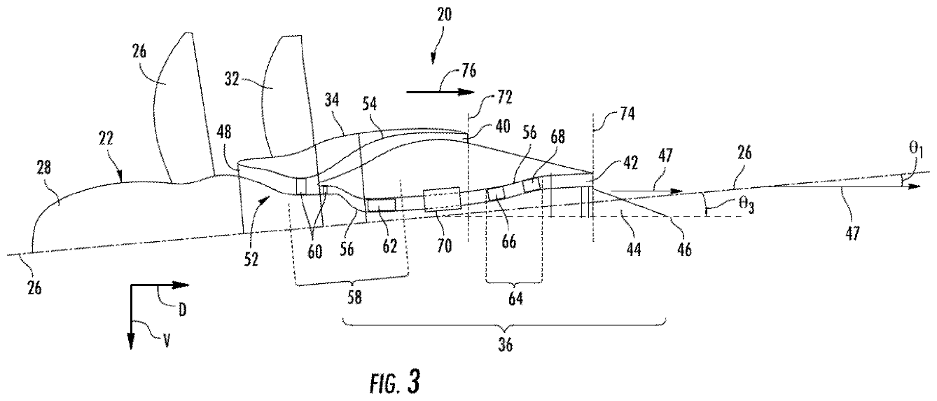

Referring now also to FIG. 3, providing a partially transparent side view of a top half of engine 20, engine 20 generally includes fan 22 and a turbomachine 52. Engine 20 defines a fan stream 76 extending from the fan blades 26 and over the turbomachine 52. In this example, fan stream 76 is depicted by an arrowhead disposed downstream from fan 22. In this example, fan stream 76 is parallel to outlet axis 46 of exhaust section 36.

Turbomachine 52 is a gas turbine engine. Turbomachine 52 defines an inlet 48 and includes exhaust section 36. As will be explained in more detail, below, exhaust section 36 generally refers to a portion of engine 20 where propulsive airflow is ejected from the turbomachine of engine 20. Exhaust section 36 is disposed downstream from fan 22. In this example, turbomachine 52 defines centerline axis 24, along which fan 22 is axially oriented.

Turbomachine 52 defines a bypass flowpath 54 and a working gas flowpath 56. Turbomachine 52 is disposed downstream of fan 22 in the embodiment depicted. In this example, turbomachine 52 is coupled to fan 22 via a shaft assembly (omitted from FIG. 3 for clarity) such that turbomachine 52 is configured to drive rotation of fan 22. Turbomachine 52 receives air through inlet 48 and produces rotational energy for fan 22 and thrust by compressing the air, igniting a mix of the air and fuel to produce a high pressure flow of combustion gasses, and expanding the combustion gasses, as will be described below.

In this example, inlet 48 is an annular opening. In other examples, inlet 48 can be non-annular. Inlet 48 is disposed between fan blades 26 and guide vanes 32 along an axial direction of engine 20.

Air from the inlet 48 is provided to the working gas flowpath and through turbomachine 52. More specifically, turbomachine 52 generally includes a compressor section 58, a combustion section (including, e.g., combustor 70), and a turbine section 64 in serial flow order. Compressor section 58, combustor 70, and turbine section 64 together define at least in part the working gas flowpath 56. In the embodiment depicted, compressor section 58 generally includes a low pressure compressor (with LPC blades 60) and a high pressure compressor (with HPC blades 62), and turbine section 64 generally including a high pressure turbine (with HPT blades 66) and a low pressure turbine (with LPT blades 68). Air from inlet 48 is progressively compressed through the low and high pressure compressors across LPC blades 60 and across HPC blades 62, respectively. The compressed air is then mixed with fuel and burned in combustor 70 to generate combustion gasses. The combustion gasses are then expanded through the high and low pressure turbines across HPT blades 66 and across LPT blades 68, respectively extracting work. In certain exemplary embodiments, the high pressure turbine may be coupled to the high pressure compressor through a shaft or spool (not shown) such that rotation of the high pressure turbine drives the high pressure compressor. Similarly, in certain exemplary embodiments, the low pressure turbine may be coupled to the low pressure compressor through a shaft or spool (not shown) such that rotation of the low pressure turbine drives the low pressure compressor. The low pressure turbine may further be configured to drive fan 22.

Airflow from the turbine section is exhausted through outlet nozzle 42 of exhaust section 36 as exhaust stream 47. Outlet nozzle 42 is an outlet nozzle for working gas flowpath 56. Turbomachine 52 further includes a core plug 44.

The outlet nozzle 42 defines a nozzle outlet plane 74. Nozzle outlet plane 74 is a plane extending along and defined by a face of bypass outlet nozzle 40. For example, with outlet nozzle 42 including an annular shape, an orientation of nozzle outlet plane 74 is defined by a plane along which an outer circumference of outlet nozzle 42 lies. Nozzle outlet plane 74 extends along the face of outlet nozzle 42. Bypass outlet nozzle plane 72 defines an exit plane of bypass outlet nozzle 40 and nozzle outlet plane 74 defines an exit plane of outlet nozzle 42. In this example, thrust is produced by fan blades 26, by bypass outlet nozzle 40, and by outlet nozzle 42. In one example, engine 20 is configured to propel aircraft 10 (and operate) at a speed of greater than Mach 0.74 (570 miles per hour) and less than Mach 0.90 (690 miles per hour). In another example, engine 20 can be configured to propel aircraft 10 (and operate) at a speed of Mach 0.79 (610 miles per hour).

Referring still to the embodiment of FIG. 3, as noted above, the turbomachine 52 further defines bypass flowpath 54 extending through a portion of turbomachine 52. Bypass flowpath 54 extends through a portion of turbomachine 52 that is disposed outward along a radial direction from working gas flowpath 56. Bypass outlet nozzle 40 of bypass flowpath 54, briefly mentioned above, is an outlet nozzle for bypass flowpath 54. In this example, bypass flowpath 54 is a third stream flowpath (as described above). Bypass flowpath 54 diverts a flow of air away from turbomachine 52 and delivers the air out of bypass outlet nozzle 40 to provide additional thrust for aircraft 10.

More specifically, for the embodiment depicted, bypass flowpath 54 extends from working gas flowpath 56 to fan stream 76. More specifically, still, for the embodiment depicted, bypass flowpath 54 extends from a low pressure compressor of compressor section 58, at a location downstream from LPC blade (e.g., a first stage of rotor blades of the low pressure compressor), to fan stream 76. In such a manner, bypass flowpath 54 may receive compressed air from working gas flowpath 56 and the airflow from bypass flowpath 54 through bypass outlet nozzle 40 may contribute to an overall thrust production of engine 20.

Although not depicted, engine 20 may further include one or more heat exchangers located in thermal communication with bypass flowpath 54 to, e.g., add energy to the airflow through bypass flowpath 54 and provide cooling to engine 20.

Bypass outlet nozzle 40 may be an annular outlet and is disposed in exhaust section 36, downstream from guide vanes 32 and upstream from outlet nozzle 42. Bypass outlet nozzle 40 defines a bypass outlet nozzle plane 72. More specifically, bypass outlet nozzle plane 72 is a plane extending along and defined by a face of bypass outlet nozzle 40 (e.g., an aft-most edge of bypass outlet nozzle 40). In this example, with bypass outlet nozzle 40 including an annular shape, an orientation of bypass outlet nozzle plane 72 is defined by a plane along which an outer circumference of bypass outlet nozzle 40 lies. Bypass outlet nozzle plane 72 extends along the face of bypass outlet nozzle 40. In other examples, bypass outlet nozzle 40 can include a non-annular shape.

It will be appreciated, however, that the exemplary engine depicted in FIG. 3 is provided by way of example only. In certain exemplary embodiments, engine 20 may have any other suitable configurations. For example, engine 20 may be a geared engine having a reduction gearbox connecting the low pressure turbine to the fan section, may be a variable pitch engine such that the fan is a variable pitch fan, may include variable pitch outlet guide vanes, and may include any other suitable number or configuration of compressors, turbines, shafts, spools, etc. Further, although engine 20 depicted includes bypass flowpath 54, in other exemplary aspects, engine 20 may not include such bypass flowpath 54 or may include bypass flowpath 54 extending from any other suitable location of compressor section 58 (e.g., from a location downstream of the low pressure compressor and upstream of the high pressure compressor, or from the high pressure compressor) to fan stream 76.

Referring still to FIG. 3, and back also to FIG. 2, in the exemplary embodiment shown, it will be appreciated that turbomachine 52 is canted downwardly relative to exhaust section 36 of engine 20. For example, exhaust section 36 defines an outlet axis 46, with centerline axis 24 defining an angle with the outlet axis 46.

In this example, turbomachine 52 is canted down relative to fuselage centerline 38. In other words, centerline axis 24 of turbomachine 52 is oriented (e.g., pitched or tilted) downwardly along vertical direction D relative to fuselage centerline 38 and relative to outlet axis 46. The pitch down arrangement of centerline axis 24 of turbomachine 52 provides for alignment of intake airflow with a face of fan 22. The pitch down arrangement of centerline axis 24 also enables exhaust section 36 to re-align an exhaust flow expelled from outlet nozzle 42 with a freestream of air flowing past aircraft 10 along downstream direction D.

More specifically, first angle θ₁ is an angle formed between centerline axis 24 of turbomachine 52 and outlet axis 46 of exhaust section 36. In one example, first angle θ₁ is greater than 0° and less than or equal to 10°, such as less than or equal to 7°. In this example, first angle θ₁ is approximately 5°. Referring particularly to FIG. 2, second angle θ₂ is an angle formed between fuselage centerline 38 and centerline axis 24 of turbomachine 52. In this example, second angle θ₂ is greater than or equal to 1° and less than or equal to 10°, such as less than or equal to 8°. Fuselage centerline 38 and centerline axis 24 may be parallel to one another.

In existing engine designs, an aircraft engine's lack of an inlet (e.g., outer nacelle surrounding fan 22) can cause misalignment of airflow with a face of the fan leading to both acoustic and performance issues. As presented herein, the pitch down arrangement of centerline axis 24 aligning a face of fan 22 with an incoming airflow (which may be oriented slightly upwardly due to an upwash effect from the wing) provides improvements with respect to both acoustics and performance. Additionally, the re-alignment of the exhaust flow with the freestream of air flowing past aircraft 10 (e.g., straightening outlet axis 46 relative to centerline axis 24) reduces hot exhaust contacting wing 14 and enables alignment of thrust with fuselage centerline 38 (e.g., an aircraft axis) or in other examples with other desired thrust vectors.

Moreover, in the exemplary embodiment of FIG. 3, bypass outlet nozzle plane 72 and nozzle outlet plane 74 are perpendicular to outlet axis 46 of exhaust section 36. In such a manner, the airflows from bypass outlet nozzle 40 and from outlet nozzle 42 are realigned relative to fan 22 so as to be parallel with outlet axis 46 and with fuselage centerline 38 (see e.g., FIGS. 1-2). In realigning the airflows from bypass outlet nozzle 40 and from outlet nozzle 42, a direction of thrust provided by engine 20 is provided in line with aircraft 10 thereby providing a more efficient thrust vector for pushing aircraft 10 through the air.

It will be appreciated that the exemplary embodiment described above with respect to FIGS. 1 through 3 is provided by way of example only. In other exemplary embodiments, engine 20 may have any other suitable configuration. For example, referring now to FIG. 4 a partially transparent side view is provided of a downstream portion of exhaust section 36 of engine 20 in accordance with another exemplary embodiment of the present disclosure. The exemplary engine 20 of FIG. 4 may be configured in a similar manner as the exemplary engine 20 of FIGS. 1 through 3. For example, the exemplary engine 20 of FIG. 4 includes a casing 34, an exhaust section 36, an outlet nozzle 42′, a core plug 44 (defining a core plug axis 78), and a rim 84, and further engine 20 depicted defines a centerline axis 24 (of fan 22, see e.g., FIGS. 1-3), an outlet axis 46, an exhaust stream 47, a working gas flowpath 56, a nozzle outlet plane 74′, a third angle θ₃, a fourth angle θ₄, a vertical direction V, and a downstream direction D.

However, by contrast to the embodiment of FIGS. 1 through 3, in the exemplary embodiment of FIG. 4, a shape of outlet nozzle 42′ is an elliptical ring. In other examples, the shape of outlet nozzle 42′ can include a non-elliptical or non-ring shape. Here, the elliptical ring shape of outlet nozzle 42′ is caused by a canted or tilted orientation of outlet nozzle 42′, as described below. In one example, a distribution of area of outlet nozzle 42′ can be continuous around the entire ring of outlet nozzle 42′. In another example, the distribution of area of outlet nozzle 42′ can be non-continuous or variable around ring of outlet nozzle 42′.

Nozzle outlet plane 74′ is an imaginary plane extending along a face of outlet nozzle 42′. In this example, nozzle outlet plane 74′ is non-orthogonal, or non-perpendicular, to outlet axis 46 of exhaust section 36. Likewise, nozzle outlet plane 74′ is non-parallel to vertical direction V and is non-perpendicular to downstream direction D. Nozzle outlet plane 74′ is defined by rim 84. In this example, nozzle outlet plane 74′ is non-orthogonal to outlet axis 46. Put another way, outlet nozzle 42′ is non-axisymmetric about outlet axis 46. In other examples, the relative angles between outlet nozzle 42′ and nozzle outlet plane 74′ relative to outlet axis 46, can also be incorporated by bypass outlet nozzle 40 and bypass outlet nozzle plane 72 (see e.g., FIG. 3).

Core plug axis 78 is a centerline axis of core plug 44. In this example, core plug axis 78 is parallel to and coaxial with outlet axis 46. As mentioned above, third angle θ₃ is a relative angle between centerline axis 24 and outlet axis 46. In this example, because core plug axis 78 is coaxial with outlet axis 46, third angle θ₃ can also be defined by the relative angle formed between centerline axis 24 and core plug axis 78. In another example, the relative angle between centerline axis 24 and core plug axis 78 can define a fourth angle θ₄ that is less than, equal to, or greater than third angle θ₃.

Core plug 44 depicted further defines an apex 80. Apex 80 is a point or tip of core plug 44. Apex 80 is disposed at a downstream-most point of core plug 44.

Terminal endpoint 82 is a downstream most point of outlet nozzle 42′. Rim 84 is a lip, or an edge disposed along a circumference of outlet nozzle 42′. Rim 84 defines nozzle outlet plane 74′ along which rim 84 is disposed. In this example, rim 84 is flat such that every point along rim 84 is disposed along a single plane (e.g., nozzle outlet plane 74′). In other examples, rim 84 can include non-flat or varying configurations (e.g., a 3D configuration) such that all points along rim 84 are not disposed along nozzle outlet plane 74′. In such examples where rim 84 includes a non-flat configuration (e.g., lobed, scalloped, chevron cut-outs, sawtooth profile, etc.), nozzle outlet plane 74′ can be defined by an average of the points along an edge of rim 84. It will be appreciated that nozzle outlet plane 74 can also be defined by a non-planar rim 84.

In this example with tilted nozzle outlet plane 74′ outlet nozzle 42′ can redirect and redistribute exhaust stream 47 so as to prevent blowing hot exhaust stream 47 onto wing 14 and to enable re-alignment of thrust with an axial centerline of aircraft 10 (see e.g., FIGS. 1-2, fuselage centerline 38) or with another desired vector.

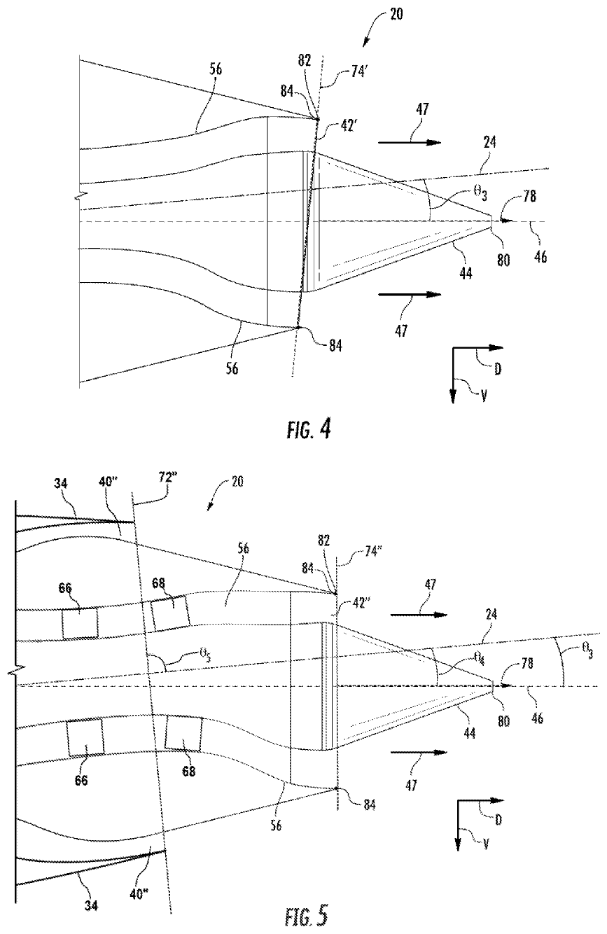

Referring now to FIG. 5, FIG. 5 shows a partially transparent side view of a downstream portion of exhaust section 36 of engine 20 in accordance with another exemplary embodiment of the present disclosure. The exemplary engine 20 of FIG. 5 may be configured in a similar manner as the exemplary engine 20 of FIGS. 1 through 3. For example, the exemplary engine 20 of FIG. 5 includes a centerline axis 24 (of fan 22), a casing 34, a bypass outlet nozzle 40″, an outlet nozzle 42″, a core plug 44 (defining a core plug axis 78), an outlet axis 46, an exhaust stream 47, a working gas flowpath 56, a HPT blade 66, an LPT blade 68, a bypass outlet nozzle plane 72″, a nozzle outlet plane 74″, an apex 80 (of core plug 44), a terminal endpoint 82 (of outlet nozzle 42″), a rim 84 (of outlet nozzle 42), a third angle θ₃, a fourth angle θ₄, a fifth angle θ₅, a vertical direction V, and a downstream direction D. HPT blade 66 and LPT blade 68 are each rotatable about the centerline axis 24.

In the exemplary embodiment of FIG. 5, bypass outlet nozzle 40″ is shown as being aligned with a direction of centerline axis 24 such that a mean direction of flow of an exhaust of the bypass outlet nozzle 40″ is parallel or substantially parallel (e.g., less than a 3 degree angle therebetween) to the centerline axis 24. Likewise, bypass outlet plane 72″ is shown in FIG. 5 as being out of alignment with (e.g., non-parallel to) nozzle outlet plane 74″. Such a configuration is in contrast with the embodiment discussed above with respect to FIG. 3, which shows bypass outlet nozzle 40 as being misaligned with a direction of centerline axis 24 and shows bypass outlet plane 72 as being in alignment with (e.g., parallel or substantially parallel to) nozzle outlet plane 74.

In certain exemplary embodiments, bypass nozzle 40″ is un-canted or aligned with centerline axis 24. More specifically, in at least certain exemplary aspects, bypass nozzle 40″ is aligned with centerline axis 24 such that fifth angle θ₅ (defined by the relative angle between centerline axis 24 and bypass outlet plane 72″) is approximately 90°. In such an example, outlet nozzle 42″ is canted or is angled relative to centerline axis 24, while bypass outlet nozzle 40″ is un-canted or is aligned with centerline axis 24 of engine 20. In a particular exemplary embodiment, fifth angle θ₅ is 90° and third angle θ₃ is greater than zero and equal to or less than 20°.

In other exemplary embodiments, fifth angle θ₅ may be less than 90° such that a complementary angle of fifth angle θ₅ is greater than zero. As used herein the term “the complementary angle” is equivalent to 90° minus another angle (e.g., fifth angle θ₅). In this example, the term complimentary angle is used to refer to the complementary angle to fifth angle θ₅. Here, the complementary angle is a degree of cant or an amount of cant of bypass outlet nozzle 40″ (and by extension of bypass outlet plane 72″) relative to centerline axis 24. More specifically, in at least certain exemplary aspects, fifth angle θ₅ may be less than 90° and equal to or greater than 85° such that the complementary angle of fifth angle θ₅ is greater than 0° and is less than or equal to 5°. In other exemplary embodiments, fifth angle θ₅ may be less than 85° and equal to or greater than 80° such that the complementary angle of fifth angle θ₅ is greater than 5° and is less than or equal to 10°.

In further certain exemplary embodiments, in combination of fifth angle θ₅ and third angle θ₃ may be greater than 5° (such as greater than or equal to 10°, such as greater than or equal to 15°). In a particular exemplary embodiment, fifth angle θ₅ is 85° such that the complementary angle of fifth angle θ₅ is 5° and third angle θ₃ is 15°.

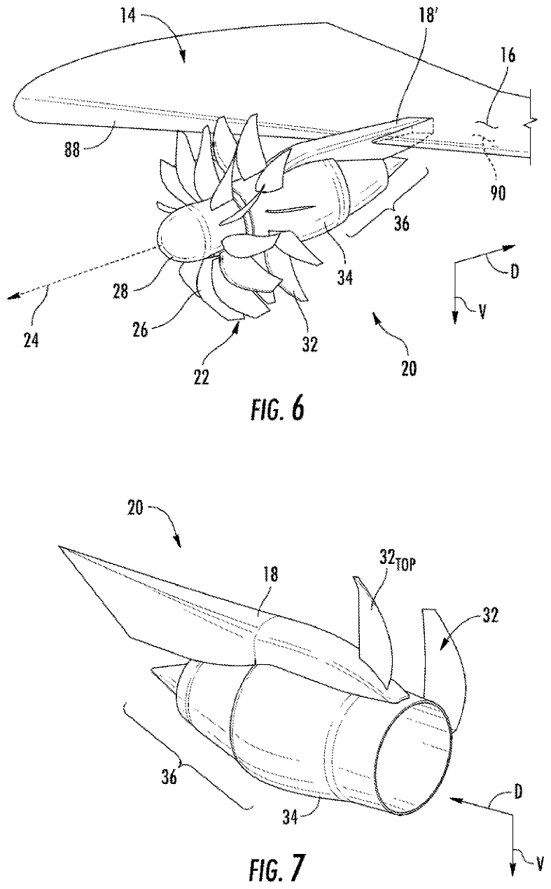

FIG. 6 is a perspective view of a portion of a wing 14 and shows an upper surface 16 of wing 14, a pylon 18′, an engine 20 (with a fan 22, a centerline axis 24, fan blades 26, a nose 28, a direction of rotation 30, guide vanes 32, a casing 34, and an exhaust section 36), a leading edge 88 of wing 14, a lower surface 90 of wing 14, a vertical direction V, and a downstream direction D.

As shown in FIG. 6, pylon 18′ includes a portion extending along upper surface 16 of wind 14. In contrast, FIGS. 1-2 include embodiments showing pylon 18 extending or connecting to wing 14 along a bottom surface of wing 14 and not along upper surface 16 of wing 14. Pylon 18′ is attached to wing 14 along upper surface 16, along leading edge 88, and along lower surface 90 of wing 14. In other examples, pylon 18′ can be mounted to wing 14 along one or more of upper surface 16, leading edge 88, and lower surface 90 of wing 14. In other examples, engine 20 could be mounted in wing 14 in any of an underwing, a blown wing, a high wing, or a fuselage mounted style of installation configuration.

Leading edge 88 is an upstream (e.g., to the left in FIG. 6) point of wing 14 relative to downstream direction D. Leading edge 88 is defined by a curved surface extending between and connecting upper surface 16 and lower surface 90 of wing 14. Leading edge 88 is disposed at an upstream-most portion of wing 14.

Lower surface 90 of wing 14 is a surface extending underneath or on a bottom of wing 14 relative to vertical direction V.

As shown in FIG. 6, an embodiment is presented of engine 20 mounted to pylon 18′ and such that portion of pylon 18′ extends along a portion of upper surface 16 of wing 14. As shown herein, having a portion of pylon 18′ extend in a downstream direction along upper surface 16 helps to guide airflow passing above wing 14 to straighten relative to downstream direction D thus enabling air flowing over wing 14 to more effectively combine with propulsive air streams generated by engine 20.

FIG. 7 is a perspective isolation view of pylon 18 mounted to a portion of engine 20 and shows a pylon 18, an engine 20, guide vanes 32, a top guide vane 32_{TOP}, a casing, an exhaust section, a vertical direction V, and a downstream direction D. In FIG. 7, fan 22 is removed from engine 20 for clarity. Here, pylon 18 is shown with one of guide vanes 32 (e.g., top guide vane 32_{TOP}) mounted to a top portion of pylon 18.

In this example two guide vanes 32 are shown in the interest of clarity. In this example, a plurality of guide vanes 32 is distributed about a circumference of casing 34 (See e.g., FIGS. 1-2 & 5). Top guide vane 32_{TOP} extends upwards from pylon 18 along a radial direction from engine 20.

As opposed to being connected to a portion of casing 34, top guide vane 32_{TOP} is mounted directly onto pylon 18. In this example, a single top guide vane 32_{TOP} is mounted onto pylon 18. I other examples, one or more top guide vane 32_{TOP} can be mounted onto pylon 18.

Existing ducted turbofans include separate outlet guide vanes and pylons which can cause separation and turbulence as different air streams pass over guide vanes and pass by pylons. In this example, outlet guide vane 32o and pylon 18 are integrated in such a way as to jointly work to de-swirl airflow from the fan (see e.g., FIGS. 1-5, fan 22) as the airflow passes across pylon 18 and optimally prepare the airflow as the airflow approaches wing 14 (see e.g., FIGS. 1-2 & 5).

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

An aircraft includes a fuselage, a wing connected to and extending outward from the fuselage, and an engine mounted to the wing. The engine includes turbomachine defining a centerline axis, a fan, and an exhaust section with an outlet nozzle. The turbomachine defines a centerline axis. The fan is connected to and is disposed upstream from the turbomachine. The fan is disposed to rotate about the centerline axis. During operation of the engine, an exhaust stream is expelled from the outlet nozzle of the exhaust section. The exhaust stream defines a mean direction of flow in the downstream direction from the exhaust section. The mean direction of flow of the exhaust stream defines a first angle with the centerline axis of the turbomachine that is greater than zero such that the centerline axis is oriented downwardly along the vertical direction relative to the mean direction of flow of the exhaust stream.

The aircraft of one or more of these clauses, wherein the first angle is less than or equal to 10°.

The aircraft of one or more of these clauses, wherein the fuselage defines a fuselage centerline, wherein the fuselage centerline defines a second angle with the centerline axis of the turbomachine, wherein the second angle is greater than or equal to 1° and less than or equal to 10°.

The aircraft of one or more of these clauses, wherein the outlet nozzle defines an outlet axis, wherein the mean direction of flow is parallel to the outlet axis.

The aircraft of one or more of these clauses, wherein the outlet nozzle defines an outlet axis, wherein the outlet axis of the outlet nozzle defines a third angle with the centerline axis of the turbomachine greater than zero and less than or equal to 20° such that the centerline axis is oriented more downwardly along the vertical direction relative to the outlet axis.

The aircraft of one or more of these clauses, wherein the fan comprises a stage of unducted rotor blades and a stage of guide vanes located downstream of the stage of unducted rotor blades, wherein the aircraft further comprises a pylon mounting the engine to the wing, and a guide vane mounted to and extending from a portion of the pylon.

The aircraft of one or more of these clauses, wherein the outlet nozzle defines an outlet axis, wherein the exhaust section comprises a core plug disposed at a downstream most end of the exhaust section, wherein the core plug defines a core plug axis and an apex, wherein the core plug axis is coaxial with the outlet axis.

The aircraft of one or more of these clauses, wherein the outlet nozzle defines an outlet axis, wherein the fuselage defines a fuselage centerline, wherein the outlet axis is parallel with the fuselage centerline.

The aircraft of one or more of these clauses, further comprising a pylon mounting the engine to the wing, wherein the wing defines an upper surface along the vertical direction and a lower surface along the vertical direction, wherein a portion of the pylon connects to and extends along a portion of the upper surface of the wing.

The aircraft of one or more of these clauses, wherein the outlet nozzle defines an outlet axis, wherein the outlet nozzle is non-axisymmetric about the outlet axis.

The aircraft of one or more of these clauses, wherein the turbomachine defines a working gas flowpath, and wherein the outlet nozzle is an outlet nozzle for the working gas flowpath.

The aircraft of one or more of these clauses, wherein the turbomachine includes a compressor section, wherein the engine defines a fan stream and a third stream, and wherein the outlet nozzle is an outlet nozzle for the third stream.

The aircraft of one or more of these clauses, wherein the engine is configured to operate at a speed greater than Mach 0.74 and less than Mach 0.90, and wherein the exhaust stream defines the mean direction of flow in the downstream direction from the exhaust section when the engine operates at the speed greater than Mach 0.74 and less than Mach 0.90.

A thrust producing system for an aircraft includes a turbomachine defining a centerline axis, a fan, and an exhaust section with an outlet nozzle. The fan is connected to and is disposed upstream from the turbomachine. The fan is disposed to rotate about the centerline axis. During operation of the thrust producing system, an exhaust stream is expelled from the outlet nozzle of the exhaust section. The exhaust stream defines a mean direction of flow in the downstream direction from the exhaust section. The mean direction of flow of the exhaust stream defines a first angle with the centerline axis of the turbomachine greater than 0° and less than or equal to 100 such that the centerline axis is oriented downwardly along the vertical direction relative to the mean direction of flow of the exhaust stream.

The thrust producing system of one or more of these clauses, wherein the outlet nozzle defines an outlet axis, wherein the mean direction of flow is parallel to the outlet axis.

The thrust producing system of one or more of these clauses, wherein the outlet nozzle defines an outlet axis, wherein the exhaust section comprises a core plug disposed at a downstream most end of the exhaust section, wherein the core plug defines a core plug axis and an apex, wherein the core plug axis is coaxial with the outlet axis.

The thrust producing system of one or more of these clauses, wherein the outlet nozzle defines an outlet axis, wherein the outlet nozzle includes a rim disposed at a terminal endpoint of the outlet nozzle, wherein the rim defines an exit plane along which the rim is disposed, wherein the exit plane is non-orthogonal to the outlet axis.

The thrust producing system of one or more of these clauses, wherein the outlet nozzle defines an outlet axis, wherein the outlet axis of the outlet nozzle defines a nozzle angle with the centerline axis of the turbomachine greater than zero and less than or equal to 20° such that the centerline axis is oriented more downwardly along the vertical direction relative to the outlet axis.

The thrust producing system of one or more of these clauses, wherein the thrust producing system is configured to operate at a speed greater than Mach 0.74 and less than Mach 0.90, and wherein the exhaust stream defines the mean direction of flow in the downstream direction from the exhaust section when the thrust producing system operates at the speed greater than Mach 0.74 and less than Mach 0.90.

The thrust producing system of one or more of these clauses, wherein the turbomachine defines a working gas flowpath, and wherein the outlet nozzle is an outlet nozzle for the working gas flowpath.

We claim:

1. An aircraft defining a vertical direction, an upstream direction, and a downstream direction, the aircraft comprising:
a fuselage;
a wing connected to and extending outward from the fuselage; and
an engine mounted to the wing, wherein the engine comprises:
a turbomachine defining a centerline axis;
a fan connected to and disposed upstream from the turbomachine, wherein the fan is disposed to rotate about the centerline axis; and
an exhaust section comprising an outlet nozzle,
wherein during operation of the engine an exhaust stream is expelled from the outlet nozzle of the exhaust section, wherein the exhaust stream defines a mean direction of flow in the downstream direction from the exhaust section, wherein the mean direction of flow of the exhaust stream defines a first angle with the centerline axis of the turbomachine greater than zero such that the centerline axis is oriented downwardly along the vertical direction relative to the mean direction of flow of the exhaust stream.

2. The aircraft of claim 1, wherein the first angle is less than or equal to 10°.

3. The aircraft of claim 1, wherein the fuselage defines a fuselage centerline, wherein the fuselage centerline defines a second angle with the centerline axis of the turbomachine, wherein the second angle is greater than or equal to 1° and less than or equal to 10°.

4. The aircraft of claim 1, wherein the outlet nozzle defines an outlet axis, wherein the mean direction of flow is parallel to the outlet axis.

5. The aircraft of claim 1, wherein the outlet nozzle defines an outlet axis, wherein the outlet axis of the outlet nozzle defines a third angle with the centerline axis of the turbomachine greater than zero and less than or equal to 20° such that the centerline axis is oriented more downwardly along the vertical direction relative to the outlet axis.

6. The aircraft of claim 1, wherein the fan comprises a stage of unducted rotor blades and a stage of guide vanes located downstream of the stage of unducted rotor blades, wherein the aircraft further comprises:
a pylon mounting the engine to the wing; and
a guide vane mounted to and extending from a portion of the pylon.

7. The aircraft of claim 1, wherein the outlet nozzle defines an outlet axis, wherein the exhaust section comprises a core plug disposed at a downstream most end of the exhaust section, wherein the core plug defines a core plug axis and an apex, wherein the core plug axis is coaxial with the outlet axis.

8. The aircraft of claim 1, wherein the outlet nozzle defines an outlet axis, wherein the fuselage defines a fuselage centerline, wherein the outlet axis is parallel with the fuselage centerline.

9. The aircraft of claim 1, further comprising:
a pylon mounting the engine to the wing,
wherein the wing defines an upper surface along the vertical direction and a lower surface along the vertical direction,
wherein a portion of the pylon connects to and extends along a portion of the upper surface of the wing.

10. The aircraft of claim 1, wherein the outlet nozzle defines an outlet axis, wherein the outlet nozzle is non-axisymmetric about the outlet axis.

11. The aircraft of claim 1, wherein the turbomachine defines a working gas flowpath, and wherein the outlet nozzle is an outlet nozzle for the working gas flowpath.

12. The aircraft of claim 1, wherein the turbomachine includes a compressor section, wherein the engine defines a fan stream and a third stream, and wherein the outlet nozzle is an outlet nozzle for the third stream.

13. The aircraft of claim 1, wherein the engine is configured to operate at a speed greater than Mach 0.74 and less than Mach 0.90, and wherein the exhaust stream defines the mean direction of flow in the downstream direction from the exhaust section when the engine operates at the speed greater than Mach 0.74 and less than Mach 0.90.

14. A thrust producing system for an aircraft, the aircraft defining a vertical direction, an upstream direction, and a downstream direction, the thrust producing system comprising:
a turbomachine defining a centerline axis;
a fan connected to and disposed upstream from the turbomachine, wherein the fan is disposed to rotate about the centerline axis; and
an exhaust section comprising an outlet nozzle,
wherein during operation of the thrust producing system an exhaust stream is expelled from the outlet nozzle of the exhaust section, wherein the exhaust stream defines a mean direction of flow in the downstream direction from the exhaust section, wherein the mean direction of flow of the exhaust stream defines a first angle with the centerline axis of the turbomachine greater than 0° and less than or equal to 10° such that the centerline axis is oriented downwardly along the vertical direction relative to the mean direction of flow of the exhaust stream.

15. The thrust producing system of claim 14, wherein the outlet nozzle defines an outlet axis, wherein the mean direction of flow is parallel to the outlet axis.

16. The thrust producing system of claim 14, wherein the outlet nozzle defines an outlet axis, wherein the exhaust section comprises a core plug disposed at a downstream most end of the exhaust section, wherein the core plug defines a core plug axis and an apex, wherein the core plug axis is coaxial with the outlet axis.

17. The thrust producing system of claim 14, wherein the outlet nozzle defines an outlet axis, wherein the outlet nozzle includes a rim disposed at a terminal endpoint of the outlet nozzle, wherein the rim defines an exit plane along which the rim is disposed, wherein the exit plane is non-orthogonal to the outlet axis.

18. The thrust producing system of claim 14, wherein the outlet nozzle defines an outlet axis, wherein the outlet axis of the outlet nozzle defines a nozzle angle with the centerline axis of the turbomachine greater than zero and less than or equal to 20° such that the centerline axis is oriented more downwardly along the vertical direction relative to the outlet axis.

19. The thrust producing system of claim 14, wherein the thrust producing system is configured to operate at a speed greater than Mach 0.74 and less than Mach 0.90, and wherein the exhaust stream defines the mean direction of flow in the downstream direction from the exhaust section when the thrust producing system operates at the speed greater than Mach 0.74 and less than Mach 0.90.

20. The thrust producing system of claim 14, wherein the turbomachine defines a working gas flowpath, and wherein the outlet nozzle is an outlet nozzle for the working gas flowpath.
